(19) United States
(12) Patent Application Publication
(10) Pub. No.: US 2026/0128584 A1
(43) Pub. Date: May 7, 2026

(54) ELECTROSTATIC DISCHARGE (ESD) DEVICE AND METHOD OF OPERATION

(71) Applicant: Infineon Technologies LLC, San Jose, CA (US)

(72) Inventors: Yan Yi, Mountain View, CA (US); Mimi QIAN, Campbell, CA (US)

(73) Assignee: Infineon Technologies LLC, San Jose, CA (US)

(21) Appl. No.: 18/938,119

(22) Filed: Nov. 5, 2024

(51) Int. Cl. H02H 9/04

(52) U.S. Cl. CPC H02H 9/046

(57) ABSTRACT

According to some embodiments, a device includes a reference supply pad, a negative supply pad, a resistor connected to the negative supply pad, and a first transistor connected to the reference supply pad and the negative supply pad and having a first gate electrode connected to the resistor, wherein responsive to an electrostatic voltage being applied to one of the reference supply pad or the negative supply pad, the first transistor is operable to shunt current to the negative supply pad.

### TECHNICAL FIELD

The present disclosure relates generally to electronic circuits, and, more particularly, to an electrostatic discharge (ESD) protection circuit for a negative supply pad.

### BACKGROUND

An integrated circuit (IC) device may include ESD protection circuits designed to protect the ICs against transient events such as ESD events and surges. An ESD protection circuit typically is designed to turn on during an ESD event and form a current discharge path to shunt large ESD current and clamp voltage of input/output (I/O) and supply pads to a sufficiently low level to prevent the IC from being damaged. The ESD protection circuit typically promotes a low resistance path to inhibit voltages from building up to potentially damaging levels.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

According to some embodiments, a device comprises a reference supply pad, a negative supply pad, a resistor connected to the negative supply pad, and a first transistor connected to the reference supply pad and the negative supply pad and having a first gate electrode connected to the resistor, wherein responsive to an electrostatic voltage being applied to one of the reference supply pad or the negative supply pad, the first transistor is operable to shunt current to the negative supply pad.

According to some embodiments, a device comprises a substrate, a metallization structure over the substrate, comprising a reference supply pad, and a negative supply pad, a first well having a first conductivity type in the substrate, a second well having a second conductivity type in the first well, a first contact having the first conductivity type in the second well and connected to the reference supply pad, a second contact having the first conductivity type in the second well and connected to the negative supply pad, a first gate electrode between the first contact and the second contact, and a resistor connected between the first gate electrode and the negative supply pad.

According to some embodiments, a method comprises connecting a resistor to a negative supply pad, connecting a first transistor between a reference supply pad and the negative supply pad, connecting the resistor to a first gate electrode of the first transistor, and responsive to an electrostatic voltage being applied to the reference supply pad, shunting current through the first transistor to the negative supply pad.

According to some embodiments, a system comprises means for connecting a resistor to a negative supply pad, means for connecting a first transistor between a reference supply pad and the negative supply pad, means for connecting the resistor to a first gate electrode of the first transistor, and responsive to an electrostatic voltage being applied to the reference supply pad, means for shunting current through the first transistor to the negative supply pad.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1A is a schematic diagram of an integrated circuit device having an electrostatic discharge protection circuit connected to a negative supply pad, according to some embodiments.

FIGS. 1B and 1C are diagrams illustrating operation of the electrostatic discharge protection circuit, in accordance with some embodiments.

FIG. 2 is a cross-section view of an electrostatic discharge protection circuit, according to some embodiments.

FIG. 3 is a layout view of an electrostatic discharge protection circuit, according to some embodiments.

FIG. 4 is a flow diagram of a method for providing electrostatic discharge protection, according to some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Equivalent or like elements or elements with equivalent or like functionality are denoted in the following description with equivalent or like reference numerals. As the same or functionally equivalent elements are given the same reference numbers in the figures, a repeated description for elements provided with the same reference numbers may be omitted. Hence, descriptions provided for elements having the same or like reference numbers are mutually exchangeable.

In this regard, directional terminology, such as “top”, “bottom”, “below”, “above”, “front”, “behind”, “back”, “leading”, “trailing”, etc., may be used with reference to the orientation of the figures being described. Because parts of embodiments can be positioned in a number of different orientations, the directional terminology is used for purposes of illustration and is in no way limiting. It is to be understood that other embodiments may be utilized and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In embodiments described herein or shown in the drawings, any direct electrical connection or coupling, i.e., any connection or coupling without additional intervening elements, may also be implemented by an indirect connection or coupling, i.e., a connection or coupling with one or more additional intervening elements, or vice versa, as long as the general purpose of the connection or coupling, for example, to transmit a certain kind of signal or to transmit a certain kind of information, is essentially maintained. Features from different embodiments may be combined to form further embodiments. For example, variations or modifications described with respect to one of the embodiments may also be applicable to other embodiments unless noted to the contrary.

The term “substantially” may be used herein to account for small manufacturing tolerances (e.g., within 5%) that are deemed acceptable in the industry without departing from the aspects of the embodiments described herein.

In an integrated circuit (IC) device external power supplies are connected to pads of the IC device to provide one or more supply voltages or reference voltages (e.g., ground). A supply voltages may be positive or negative with respect to the reference voltage. One difficulty of providing ESD protection for a negative supply pad is avoiding having the protection device (e.g., diode) being forward biased during normal operation to provide proper operation of the IC device components being supplied with the negative supply voltage.

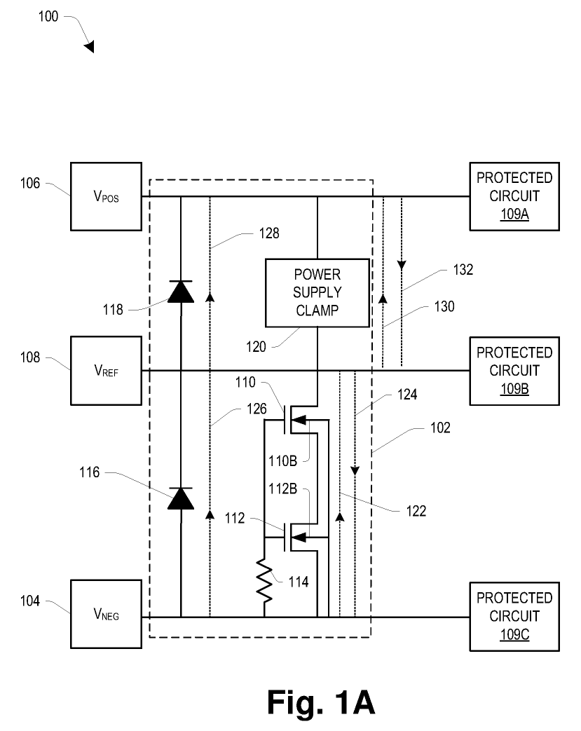

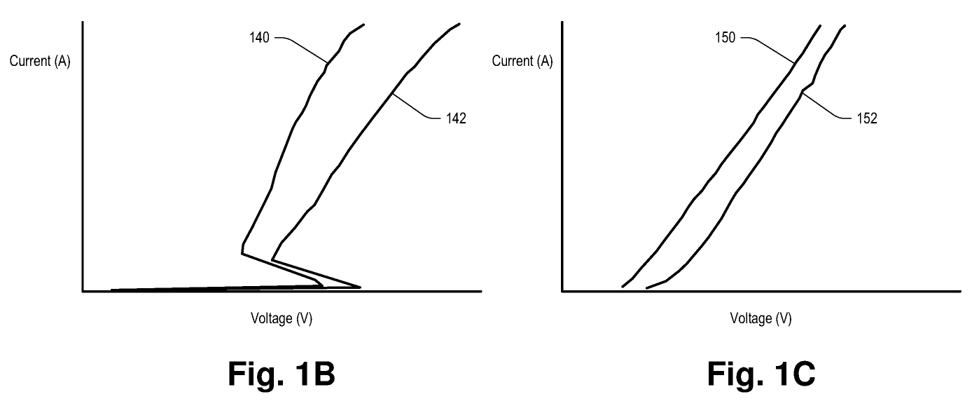

FIG. 1A is a schematic diagram of an integrated circuit device 100 including an electrostatic discharge (ESD) protection circuit 102 connected to a negative supply pad 104, according to some embodiments. In some embodiments, the IC device 100 comprises a positive supply pad 106 and a reference supply pad 108. Relative to a provided reference supply voltage (V_{REF}), such as ground, a positive supply voltage (V_{POS}) is applied to the positive supply pad 106 and a negative supply voltage (V_{NEG}) is applied to the negative supply pad 104 in a normal operating mode. The ESD protection circuit 102 shunts current from ESD events to avoid damaging protected circuits 109A, 109B, and/or 109C connected to one or more of the pads 104, 106, and/or 108. Example protected circuits 109A, 109B, and/or 109C include memory device circuits, logic device circuits, switching circuits, power regulator circuits, amplifier circuits, sensor circuits, or some other circuits with components sensitive to ESD events.

In some embodiments, the ESD protection circuit 102 comprises cascoded transistors 110, 112 connected between the negative supply pad 104 and the reference supply pad 108 to shunt current resulting from an ESD event. In some embodiments, the gate terminal of the transistor 112 is connected through a resistor 114 to the negative supply pad 104 so as to maintain the transistor 112 in an off state during normal operation. The gate terminal of the transistor 110 may be connected to the resistor 114. In alternative embodiments, the gate terminal of the transistor 110 may be floating, may be connected by a resistor (not shown) to the reference supply pad 108, or may be connected by a resistor (not shown) to the drain of the transistor 112. Although the transistors 110, 112 are held in an off state during normal operation, body diodes 110B, 112B of the transistors 110, 112 conduct current in response to ESD events. In some embodiments, the number of transistors 110, 112 (e.g., from 1 to N) depending on the voltage protection requirements of the IC device 100. At least the last transistor 112 has a gate terminal connected to the negative supply pad 104 by the resistor 114.

In some embodiments, additional ESD protection is provided by a diode 116 connected between the negative supply pad 104 and the reference supply pad 108, a diode 118 connected between the reference supply pad 108 and the positive supply pad 106, or a power supply clamp 120 connected between the positive supply pad 106 and the reference supply pad 108. In some embodiments, the anode of the diode 116 is connected to the negative supply pad 104, and the anode of the diode 118 is connected to the reference supply pad 108. In some embodiments, the power supply clamp 120 is an ESD protection structure that shuts off during normal operation and turns on during an ESD event to conduct current to keep the voltage at a safe level to protect the supply pads 106, 108 from overvoltage damage.

The ESD protection circuit 102 provides an ESD discharge path 122 from the negative supply pad 104 to the reference supply pad 108 or an ESD discharge path 124 from the reference supply pad 108 to the negative supply pad 104. In some embodiments, the diode 116 is biased to provide an ESD discharge path 126 from the negative supply pad 104 to the reference supply pad 108, the diode 118 is biased to provide an ESD discharge path 128 from the reference supply pad 108 to the positive supply pad 106, and the power supply clamp 120 is biased to provide an ESD discharge path 130 from the reference supply pad 108 to the positive supply pad 106 or an ESD discharge path 132 from the positive supply pad 106 to the reference supply pad 108. ESD events may have positive or negative polarities, so the ESD discharge path 122, 124, 126, 128, 130, 132 activated for a given ESD event depends on the polarity of the ESD event and the pad 104, 106, 108 where the ESD event is applied.

FIGS. 1B and 1C are diagrams illustrating operation of the electrostatic discharge protection circuit 102, in accordance with some embodiments. FIG. 1B shows a current-voltage (I-V) curve 140 illustrating operation of the cascoded transistors 110, 112 in reverse-biased mode to activate the ESD discharge path 124 in response to a positive ESD voltage applied to the reference supply pad 108 to discharge current through the negative supply pad 104.

FIG. 1B also shows an I-V curve 142 illustrating operation of the power supply clamp 120 to activate the ESD discharge path 132 and the operation of the cascoded transistors 110, 112 in reverse-biased mode to activate the ESD discharge path 124 to discharge current through the negative supply pad 104 in response to a positive ESD voltage applied to the positive supply pad 106. The I-V curves 140, 142 illustrate that the voltage across the cascoded transistors 110, 112 increases until the breakdown voltage of the body diodes 110B, 112B is reached and snap back occurs.

FIG. 1C shows an I-V curve 150 illustrating operation of the cascoded transistors 110, 112 in forward-biased mode to activate the ESD discharge path 122 in response to a positive ESD voltage applied to the negative supply pad 104 to discharge current through the reference supply pad 108. In response to the positive ESD voltage applied to the negative pad 104, the diode 116 also activates to enable the ESD discharge path 126.

FIG. 1C also shows an I-V curve 152 illustrating operation of the power supply clamp 120 to activate the ESD discharge path 130 and the operation of the cascoded transistors 110, 112 in forward-biased mode to activate the ESD discharge path 122 to discharge current through the positive supply pad 106 in response to a positive ESD voltage applied to the negative supply pad 104. The I-V curves 150, 152 illustrate that the voltage across the cascoded transistors 110, 112 increases until the threshold voltage of the body diodes 110B, 112B is reached and conduction occurs. In response to the positive ESD voltage applied to the negative supply pad 104, the diodes 116, 118 are also activated to enable the ESD discharge paths 126, 128, respectively.

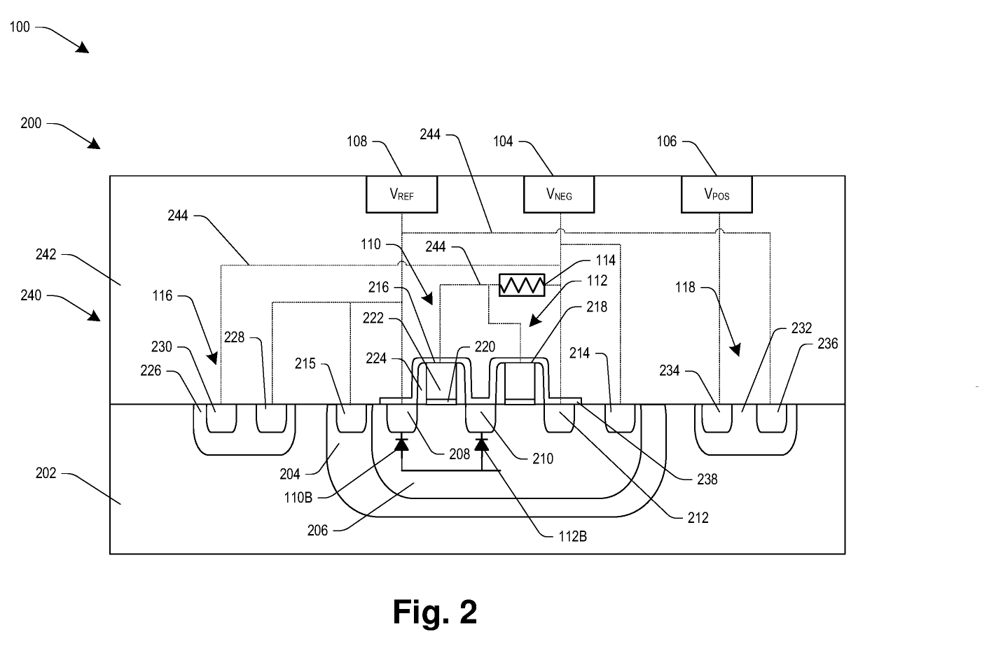

FIG. 2 is a cross-section view of the electrostatic discharge protection circuit 102, according to some embodiments. In some embodiments, the electrostatic discharge protection circuit 102 is a semiconductor device 200 formed in and above a substrate 202. A deep n-well 204 is formed in the substrate 202 and a p-well 206 is formed in the deep n-well. In some embodiments, the deep n-well 204 is doped with an impurity having n-type conductivity, such as phosphorus, arsenic, antimony, tellurium, sulfur, or some other n-type impurity, and the p-well 206 is doped with an impurity having p-type conductivity, such as such as boron, gallium, zinc, aluminum, or some other p-type impurity. N-type contact regions 208, 210, 212 and p-type contact region 214 are formed in the p-well 206. An n-type contact region 215 is formed in the deep n-well 204. Contact regions 208, 210, 212, 214 may be active regions, such as source/drain regions, and may be formed by implantation, diffusion, epitaxial growth, or some other process to introduce dopants or impurities of the specified conductivity type. The conductivity type represents the net conductivity type. For example, since the contact regions 208, 210, 212 are formed in the p-well 206, p-type impurities are present, but a greater concentration of n-type impurities is present to define the net conductivity type. Gate structures 216, 218 are formed over the substrate 202. In some embodiments, the gate structures 216, 218 each comprise a gate insulation layer 220 (e.g., dielectric), a gate electrode 222 (e.g., polysilicon, metal), and sidewall spacers 224 adjacent the gate insulation layer 220 and the gate electrode 222. The p-well 206, the N-type contact regions 208, 210, and the gate structure 216 define the transistor 110, and the p-well 206, the N-type contact regions 210, 212, and the gate structure 216 define the transistor 112. The n-type contact regions 208, 210 and the p-well 206 define the body diodes 110B, 112B.

In some embodiments, an n-well 226 is formed in the substrate 202 and a p-type contact region 228 connected to the reference supply pad 108 and an n-type contact region 230 connected to the negative supply pad 104 are formed in the n-well to define the diode 116. An n-well 232 is formed in the substrate 202 and an n-type contact region 234 connected to the positive supply pad 106 and a p-type contact region 236 connected to the reference supply pad 108 are formed in the n-well 202 to define the diode 118.

In some embodiments, a silicide block layer 238 is formed over the substrate 202 to enhance the ESD characteristics of the semiconductor device 200. In some embodiments, the silicide block layer 238 covers at least some of the contact regions 208, 210, 212, the gate electrodes 216, 218, and the sidewall spacers 224 to block the formation of a silicide layer present in other portions of the integrated circuit device 100, where a silicide layer generally reduces resistance wherever the silicide layer is present.

In some embodiments, a metallization structure 240 is formed over the substrate to provide the connections between the transistors 110, 112, the resistor 114, and the diodes 116, 118 to the negative supply pad 104, the positive supply pad 106, or the reference supply pad 108, as described above. The n-type contact region 208 and the n-type contact region 215 are connected to the reference supply pad 108. The n-type contact region 212 and the p-type contact region 214 are connected to the negative supply pad 104. The metallization structure 240 may include one or more dielectric layers 242 and interconnect structures 244. For ease of illustration, the interconnect structures 244 are shown in simplified form. In an actual device, the interconnect structures 244 may be formed using a network of conductive lines and conductive vias in a stacked arrangement to provide the illustrated connections. In some embodiments, the resistor 114 is formed using a polysilicon line in the same layer as the gate electrodes 222. Alternatively, the resistor 114 may be formed using a resistive structure in a layer of the metallization structure 240.

The ESD protection circuit 102 includes the gate grounded transistors 110, 112 in the isolated p-well 206 without any forward biased diodes from the p-well 206 to the n-type contact regions 208, 210, 212. The p-well 206 and the n-type contact region 212 are tied to the negative supply pad 104 (<0V). The voltage on any of the n-type contact regions 208, 210, 212 will not be lower than that of the P-well 206, so there are no forward biased diodes during normal operation. In some embodiments, the deep n-well 104 is tied to the reference supply pad 108 or the positive supply pad 106 as long as the voltage between the negative connected p-well 206 and the reference or positive connected deep n-well 204 does not exceed the junction breakdown voltage.

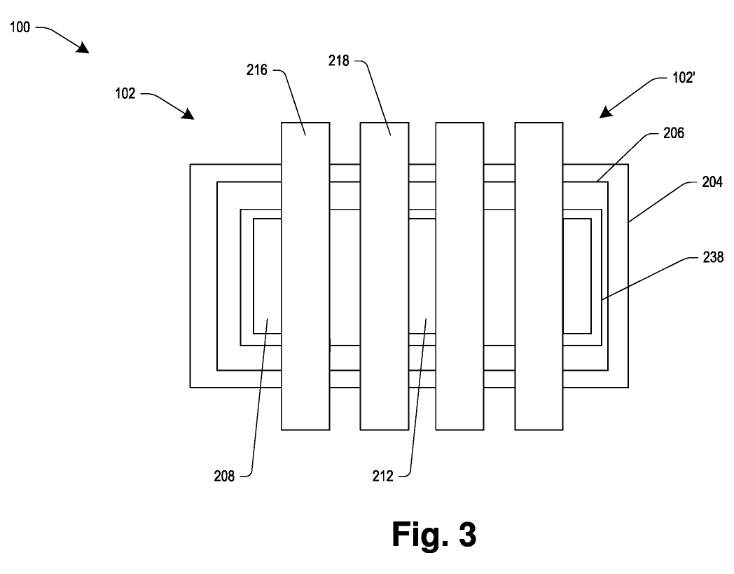

FIG. 3 is a layout view of an electrostatic discharge protection circuit 102, according to some embodiments. In some embodiments, the silicide block layer 238 covers the substrate 202 over the deep n-well 204 and the p-well 206. The gate structures 216, 218 are formed over the substrate 202. Openings may be formed in the silicide block layer 238 to expose the n-type contact regions 208, 212 to allow connections to be made to the transistors 110, 112. FIG. 3 illustrates an adjacent electrostatic discharge protection circuit 102’ where the n-type contact region 212 may be shared between adjacent circuits.

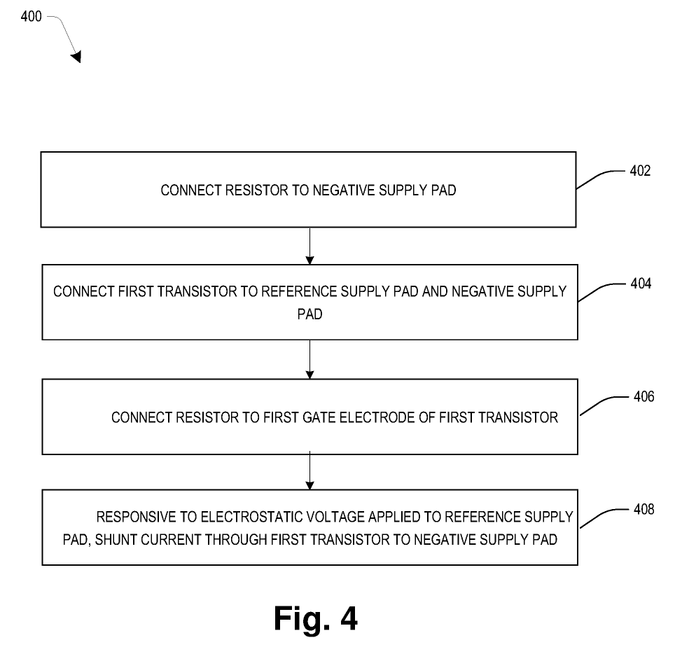

FIG. 4 is a flow diagram of a method 400 for providing electrostatic discharge protection, according to some embodiments. At 402, a resistor 114 is connected to a negative supply pad 104. At 404, a first transistor 110 is connected to a reference supply pad 108 and the negative supply pad 104. At 406, the resistor 114 is connected to a first gate electrode of the first transistor 110. At 408, responsive to an electrostatic voltage being applied to the reference supply pad 108, current is shunted through the first transistor 110 to the negative supply pad 104.

According to some embodiments, a device comprises a reference supply pad, a negative supply pad, a resistor connected to the negative supply pad, and a first transistor connected to the reference supply pad and the negative supply pad and having a first gate electrode connected to the resistor, wherein responsive to an electrostatic voltage being applied to one of the reference supply pad or the negative supply pad, the first transistor is operable to shunt current to the negative supply pad.

According to some embodiments, the device comprises a second transistor connected to at least one of the reference supply pad or the negative supply pad in series with the first transistor and having a second gate electrode connected to the resistor.

According to some embodiments, the first transistor comprises an n-type transistor.

According to some embodiments, the device comprises a diode connected between the reference supply pad and the negative supply pad, wherein an anode of the diode is connected to the negative supply pad.

According to some embodiments, the device comprises a positive supply pad, and a power supply clamp connected between the positive supply pad and the reference supply pad.

According to some embodiments, the device comprises a first diode connected between the reference supply pad and the negative supply pad, and a second diode connected between the reference supply pad and the positive supply pad.

According to some embodiments, a device comprises a substrate, a metallization structure over the substrate, comprising a reference supply pad, and a negative supply pad, a first well having a first conductivity type in the substrate, a second well having a second conductivity type in the first well, a first contact having the first conductivity type in the second well and connected to the reference supply pad, a second contact having the first conductivity type in the second well and connected to the negative supply pad, a first gate electrode between the first contact and the second contact, and a resistor connected between the first gate electrode and the negative supply pad.

According to some embodiments, the device comprises a third contact having the first conductivity type in the second well, and a second gate electrode between the second contact and the third contact, wherein the resistor is connected between the second gate electrode and the negative supply pad.

According to some embodiments, the device comprises a third contact having the second conductivity type in the second well and connected to the negative supply pad.

According to some embodiments, the device comprises a third contact having the first conductivity type in the first well and connected to the reference supply pad.

According to some embodiments, the device comprises a silicide blocking layer over portions of the first contact, the second contact, and the first gate electrode.

According to some embodiments, the first conductivity type comprises n-type conductivity and the second conductivity type comprises p-type conductivity.

According to some embodiments, the device comprises a third well having the first conductivity type in the substrate, a third contact having the first conductivity type in the third well and connected to the reference supply pad, and a fourth contact having the second conductivity type in the third well and connected to the negative supply pad.

According to some embodiments, the metallization structure comprises a positive supply pad and the device further comprises a third well having the first conductivity type in the substrate, a third contact having the first conductivity type in the third well and connected to the reference supply pad, and a fourth contact having the second conductivity type in the third well and connected to the positive supply pad.

According to some embodiments, a method comprises connecting a resistor to a negative supply pad, connecting a first transistor between a reference supply pad and the negative supply pad, connecting the resistor to a first gate electrode of the first transistor, and responsive to an electrostatic voltage being applied to the reference supply pad, shunting current through the first transistor to the negative supply pad.

According to some embodiments, the method comprises connecting a second transistor between the reference supply pad and the negative supply pad in series with the first transistor, connecting the resistor to a second gate electrode of the second transistor, and responsive to the electrostatic voltage being applied to the reference supply pad, shunting the current through the first transistor and the second transistor to the negative supply pad.

According to some embodiments, the method comprises connecting a diode between the reference supply pad and the negative supply pad, wherein an anode of the diode is connected to the negative supply pad, and responsive to a second electrostatic voltage being applied to the negative supply pad, shunting second current through the first transistor to the reference supply pad and shunting third current through the diode to the reference supply pad.

According to some embodiments, the method comprises connecting a power supply clamp between a positive supply pad and the reference supply pad and responsive to a second electrostatic voltage being applied to the positive supply pad, shunting second current through the power supply clamp and the first transistor to the negative supply pad.

According to some embodiments, the method comprises connecting a first diode between the reference supply pad and the negative supply pad, wherein an anode of the first diode is connected to the negative supply pad, connecting a second diode between the reference supply pad and the positive supply pad, wherein an anode of the second diode is connected to the reference supply pad, and responsive to a third electrostatic voltage being applied to the negative supply pad, shunting third current through the first transistor and the power supply clamp to the positive supply pad and shunting fourth current through the first diode and the second diode to the positive supply pad.

According to some embodiments, connecting the first transistor to the reference supply pad and the negative supply pad comprises connecting an n-type transistor to the reference supply pad and the negative supply pad.

Although the subject matter has been described in language specific to structural features or methodological acts, it is to be understood that the subject matter of the appended claims is not necessarily limited to the specific features or acts described above. Rather, the specific features and acts described above are disclosed as example forms of implementing at least some of the claims.

Various operations of embodiments are provided herein. The order in which some or all of the operations are described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Moreover, "exemplary" and/or the like is used herein to mean serving as an example, instance, illustration, etc., and not necessarily as advantageous. Rather, use of the word “example” and/or the like is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, "or" is intended to mean an inclusive "or" rather than an exclusive "or". In addition, "a" and "an" as used in this application and the appended claims are generally to be construed to mean "one or more" unless specified otherwise or clear from context to be directed to a singular form. Also, at least one of A and B and/or the like generally means A or B or both A and B. Furthermore, to the extent that "includes", "having", "has", "with", or variants thereof are used, such terms are intended to be inclusive in a manner similar to the term "comprising”. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others of ordinary skill in the art based upon a reading and understanding of this specification and the annexed drawings. The disclosure comprises all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application. Furthermore, to the extent that the terms "includes", "having", "has", "with", or variants thereof are used in either the detailed description or the claims, such terms are intended to be inclusive in a manner similar to the term "comprising."

What is claimed is:

1. A device, comprising:
a reference supply pad;
a negative supply pad;
a resistor connected to the negative supply pad; and
a first transistor connected to the reference supply pad and the negative supply pad and having a first gate electrode connected to the resistor, wherein responsive to an electrostatic voltage being applied to one of the reference supply pad or the negative supply pad, the first transistor is operable to shunt current to the negative supply pad.

2. The device of claim 1, comprising:
a second transistor connected to at least one of the reference supply pad or the negative supply pad in series with the first transistor and having a second gate electrode connected to the resistor.

3. The device of claim 1, wherein:
the first transistor comprises an n-type transistor.

4. The device of claim 1, comprising:
a diode connected between the reference supply pad and the negative supply pad, wherein an anode of the diode is connected to the negative supply pad.

5. The device of claim 1, comprising:
a positive supply pad; and
a power supply clamp connected between the positive supply pad and the reference supply pad.

6. The device of claim 5, comprising:
a first diode connected between the reference supply pad and the negative supply pad; and
a second diode connected between the reference supply pad and the positive supply pad.

7. A device, comprising:
a substrate;
a metallization structure over the substrate, comprising:
a reference supply pad; and
a negative supply pad;
a first well having a first conductivity type in the substrate;
a second well having a second conductivity type in the first well;
a first contact having the first conductivity type in the second well and connected to the reference supply pad;
a second contact having the first conductivity type in the second well and connected to the negative supply pad;
a first gate electrode between the first contact and the second contact; and
a resistor connected between the first gate electrode and the negative supply pad.

8. The device of claim 7, comprising:
a third contact having the first conductivity type in the second well; and
a second gate electrode between the second contact and the third contact, wherein:
the resistor is connected between the second gate electrode and the negative supply pad.

9. The device of claim 7, comprising:
a third contact having the second conductivity type in the second well and connected to the negative supply pad.

10. The device of claim 7, comprising:
a third contact having the first conductivity type in the first well and connected to the reference supply pad.

11. The device of claim 7, comprising:
a silicide blocking layer over portions of the first contact, the second contact, and the first gate electrode.

12. The device of claim 7, wherein:
the first conductivity type comprises n-type conductivity; and
the second conductivity type comprises p-type conductivity.

13. The device of claim 7, comprising:
a third well having the first conductivity type in the substrate;
a third contact having the first conductivity type in the third well and connected to the reference supply pad; and
a fourth contact having the second conductivity type in the third well and connected to the negative supply pad.

14. The device of claim 7, wherein:
the metallization structure comprises a positive supply pad; and
the device further comprises:
a third well having the first conductivity type in the substrate;
a third contact having the first conductivity type in the third well and connected to the reference supply pad; and
a fourth contact having the second conductivity type in the third well and connected to the positive supply pad.

15. A method comprising:
connecting a resistor to a negative supply pad;
connecting a first transistor between a reference supply pad and the negative supply pad;
connecting the resistor to a first gate electrode of the first transistor; and
responsive to an electrostatic voltage being applied to the reference supply pad, shunting current through the first transistor to the negative supply pad.

16. The method of claim 15, comprising:
connecting a second transistor between the reference supply pad and the negative supply pad in series with the first transistor;
connecting the resistor to a second gate electrode of the second transistor; and
responsive to the electrostatic voltage being applied to the reference supply pad, shunting the current through the first transistor and the second transistor to the negative supply pad.

17. The method of claim 15, comprising:
connecting a diode between the reference supply pad and the negative supply pad, wherein an anode of the diode is connected to the negative supply pad; and
responsive to a second electrostatic voltage being applied to the negative supply pad:
shunting second current through the first transistor to the reference supply pad; and
shunting third current through the diode to the reference supply pad.

18. The method of claim 15, comprising:
connecting a power supply clamp between a positive supply pad and the reference supply pad; and
responsive to a second electrostatic voltage being applied to the positive supply pad, shunting second current through the power supply clamp and the first transistor to the negative supply pad.

19. The method of claim 18, comprising:
connecting a first diode between the reference supply pad and the negative supply pad, wherein an anode of the first diode is connected to the negative supply pad;
connecting a second diode between the reference supply pad and the positive supply pad, wherein an anode of the second diode is connected to the reference supply pad; and
responsive to a third electrostatic voltage being applied to the negative supply pad:
shunting third current through the first transistor and the power supply clamp to the positive supply pad; and
shunting fourth current through the first diode and the second diode to the positive supply pad.

20. The method of claim 15, wherein:
connecting the first transistor to the reference supply pad and the negative supply pad comprises:
connecting an n-type transistor to the reference supply pad and the negative supply pad.
